(19) United States
(12) Patent Application Publication
(10) Pub. No.: US 2006/0165470 A1
(43) Pub. Date: Jul. 27, 2006

(54) Connector systems and marker systems comprising same

(75) Inventor: Matthew Justin Gerules, Chicago, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: SANFORD, L.P.

(21) Appl. No.: 11/339,026

(22) Filed: Jan. 25, 2006

Related U.S. Application Data
(60) Provisional application No. 60/647,666, filed on Jan. 26, 2005.

(51) Int. Cl. B43K 27/02; B05C 1/00

(52) U.S. Cl. 401/18; 401/17

(57) ABSTRACT

The disclosure is generally directed to a marker system and, more particularly, to a marker system comprising a first instrument, a second instrument, and a connector cap for receiving the first and second instruments.

### CROSS-REFERENCE To RELATED APPLICATION

The benefit under 35 U.S.C. §119(e) of U.S. provisional patent application Ser. No. 60/647,666 filed Jan. 26, 2005, the entire disclosure of which is incorporated herein by reference, is hereby claimed.

### BACKGROUND OF THE DISCLOSURE

1. Field of the Disclosure

The disclosure is generally directed to a connector system and, more particularly, to a connector system comprising a first instrument, a second instrument, and a connector cap for receiving the first and second instruments.

2. Brief Description of Related Technology

Many consumers prefer to use more than one writing implement while working on an individual project, for example, in order to write and/or otherwise make illustrations with different types of written marks. For example, the use of different colors is advantageous in that it allows a consumer to emphasize and/or contrast selected written marks relative to other written marks. The use of different types of writing points similarly permits a consumer to emphasize and/or contrast selected text. Unfortunately, consumers do not always have access to multiple writing implements because work space and storage space are often limited. Thus, compact, “pen-style” tools capable of making different types of written marks have been developed.

An exemplary marker, which is capable of making different types of written marks, is produced under the trade name SHARPIE® TWIN-TIP™ (Sanford, L.P., Oak Brook, Ill.). This marker includes two marking nibs disposed at opposite ends of the marker. One of the marking nibs is a robust, relatively thicker nib (i.e., a bold point nib) capable of making relatively thick written marks, and the other is a fine point nib capable of making relatively fine written marks. The marker includes two separate caps and utilizes a single ink reservoir, which holds a single ink

A similar exemplary marker capable of making different colored written marks also includes two marking nibs disposed at opposite ends of the marker, but each of the marking nibs is in fluid communication with a separate ink reservoir (specifically, one nib is in fluid communication with a first ink reservoir containing a first ink composition, and the other nib is in fluid communication with a second ink reservoir containing a second ink composition). The marker barrel contains an interior barrier wall at its center in order to prevent the first ink composition contained in the first ink reservoir from contaminating the second ink composition contained in the second ink reservoir. The ink reservoirs for such markers typically hold small amounts of ink composition. Moreover, these markers are relatively long, and therefore when one of the caps is removed and positioned at the other end of the marker so as to expose a writing point, the product is relatively long and has an unsightly appearance.

Another exemplary writing implement capable of making different types of written marks is a pen which incorporates multiple thin tube-like reservoirs into a single barrel. The barrels of such pens are relatively thick compared to pens having only a single thin tube-like reservoir. Because markers generally require larger reservoirs, one cannot fit a plurality of marker-type reservoirs into a marker barrel without creating a marker that is too wide to be comfortably gripped by a typical consumer. Thus, this style of writing implement is not suited for marker applications.

Another exemplary writing implement capable of delivering different types of written marks is produced under the trade name TANDEM® (Sanford, L.P., Oakbrook, Ill.). This writing implement incorporates a conventional pen and ink system at one end, and a removable highlighter marker at the other opposing end. The highlighter marker is releasably coupled to the writing implement housing, and is replaceable.

An additional exemplary writing implement capable of delivering different types of written marks includes multiple markers, which are removable from a central docking station. The removable markers and complementary docking station have configurations which prevent consumers from using each of the markers comfortably.

### BRIEF DESCRIPTION OF THE DRAWINGS

Exemplary aspects and features of a marker system in accordance with the disclosure are described and explained in greater detail below with the aid of the drawing figures in which:

FIG. 1 is a perspective view of an exemplary marker system according to the disclosure;

FIG. 2 is a partially exploded view of the marker system of FIG. 1, wherein one writing point is exposed;

FIG. 3 is an exploded view of the marker system of FIG. 1, wherein two writing points are exposed;

FIG. 4 is a side view of the marker system of FIG. 1, wherein one instrument is received within the connector cap such that one writing point is positioned for making written marks;

FIG. 5 is a perspective view of a second embodiment of a marker system according to the disclosure;

FIG. 6 is a perspective view of a third embodiment of a marker system according to the disclosure;

FIG. 7 is an exploded view of the marker system of FIG. 6, wherein two writing points are exposed; and,

FIG. 8 is a side view of the marker system of FIG. 6, wherein one instrument is received within the connector cap such that one writing tip is positioned for making written marks.

### DETAILED DESCRIPTION

In one embodiment, the disclosure provides a connector system comprising a first instrument, a second instrument, and a connector cap for receiving the first and second instruments. In a preferred embodiment, the connector system comprises a marker system wherein at least one of the first and seconds instruments comprises a writing implement. Advantageously, the marker system is typically configured in the shape and form of a traditional pen-style marker.

In a further embodiment, the disclosure provides a kit comprising a marker system including a plurality of markers, and a connector cap for receiving two of the markers. The plurality of markers can include different types of writing points (e.g., bold point nibs, fine point nibs, ‘chiseled’ nibs, etc.). Additionally, each of the plurality of markers can include an ink reservoir containing an ink composition having a different color.

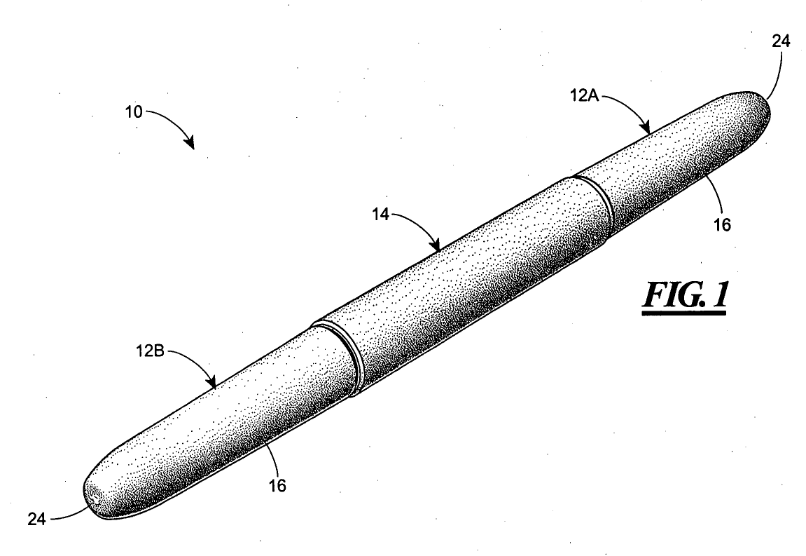

Embodiments of the connector system according to the disclosure generally include marker systems 10, which are shown generally in FIGS. 1-8. The marker systems 10 include a first instrument 12A, a second instrument 12B, and a connector cap 14 for receiving the first and second instruments 12A, 12B. As shown, the marker systems 10 contain two identical markers 12A, 12B disposed at first and second opposing ends of the central connector cap 14. Because the markers 12A, 12B are generally identical (in shape and configuration), they are interchangeable with respect to the connector cap 14, such that either marker 12A, 12B may be received by either end of connector cap 14. Of course, the markers 12A, 12B need not be generally identical.

Thus, according to one aspect, the first and second instruments 12A, 12B comprise a first writing implement 12A and a second writing implement 12B, respectively. According to one refinement of this aspect, the first and second writing implements 12A, 12B are capable of delivering different ink compositions. The writing implements 12A, 12B are typically markers, ball point pens, roller pens, fountain pens, and mechanical pencils. In alternative embodiments (not shown), at least one of the first and second instruments 12A, 12B comprises a stylus (for example, for a hand-held electronic organizer device), a laser pointer, a brush, a flashlight, a keychain holder, a storage container, or a similar device.

The writing implements 12A, 12B include an ink reservoir (not shown) disposed in a housing or barrel 16. The ink reservoir is in fluid communication with a writing point 18, typically a porous nib, which extends from a marker ferrule 20. The ink reservoir can contain any type of ink composition including but not limited to highlighter ink compositions, permanent marker ink compositions, and dry erase ink compositions.

The connector cap 14 is generally a tubular member that can be coupled to the marker ferrule 20 to seal the writing implements 12A, 12B and prevent the writing points 18 from drying out when the marker system is stored for subsequent use. In an alternate embodiment, the connector cap 14 is a cylindrical member.

The connector cap 14 often includes an interior protruding snap-ring (or other similar protruding structure) (not shown), and the marker ferrule 20 often includes corresponding structure (e.g., at least one raised surface) (also not shown) in order to provide a snap-fit, and preferably a sealing snap-fit, between these components. The connector cap 14 may also include an interior wall 26, but is otherwise a generally hollow structure which does not include ink system components such as a writing nib, an ink reservoir, and a feed rod.

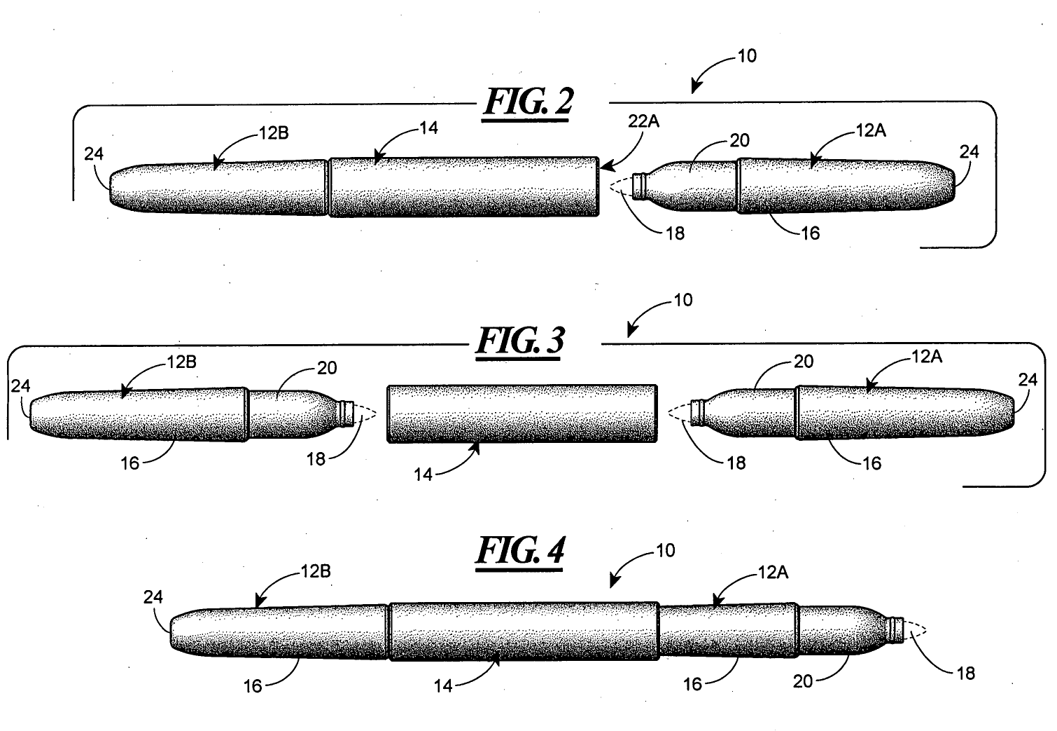

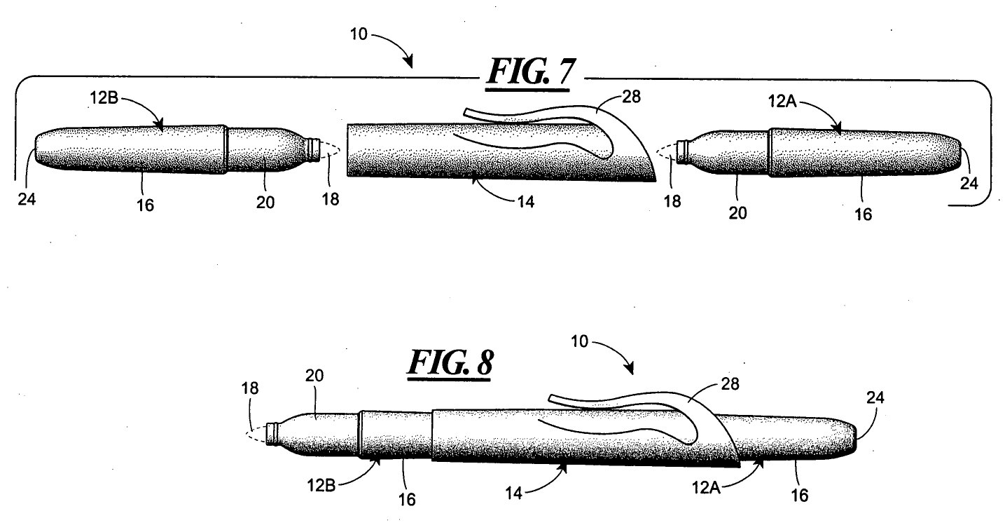

The connector cap 14 has a first receiving chamber 22A and a second receiving chamber 22B for receiving either the marker barrel 16 (or other instrument housing) or the marker ferrule 20. FIG. 2 is a partially exploded view of the marker system 10 illustrating the removal of a desired marker 12A from a receiving chamber 22A of the central connector cap 14. FIGS. 3 and 7 illustrate that the second instrument 12B (shown as a second writing implement) can also be removed simultaneously from the second receiving chamber 22B of the central connector cap 14. Once the desired marker 12A, 12B is removed from the marker system 10, it can be used (by itself) for making written marks. Another option is to orient at least one of the removed markers 12A, 12B such that the non-writing end 24 thereof is inserted into a receiving chamber 22A, 22B of the center connector cap 14. As best shown in FIGS. 4 and 8, the marker system 10 can then be used as a single regular-sized marker.

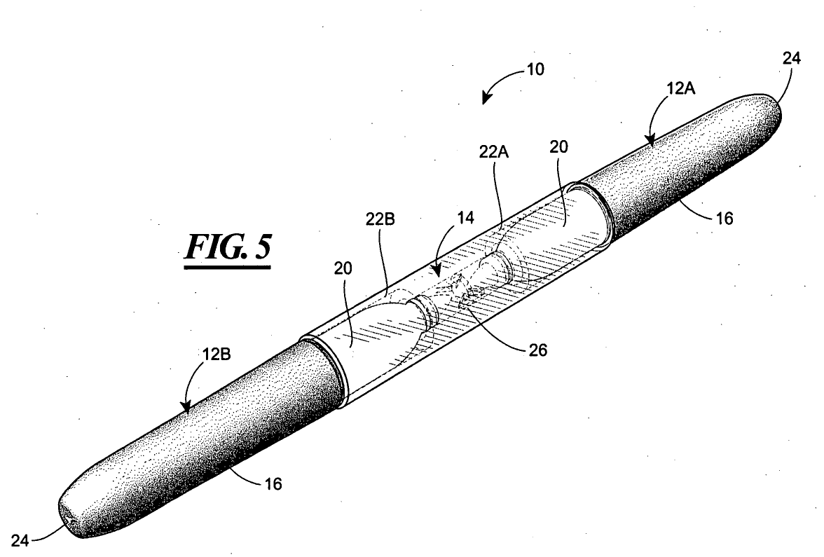

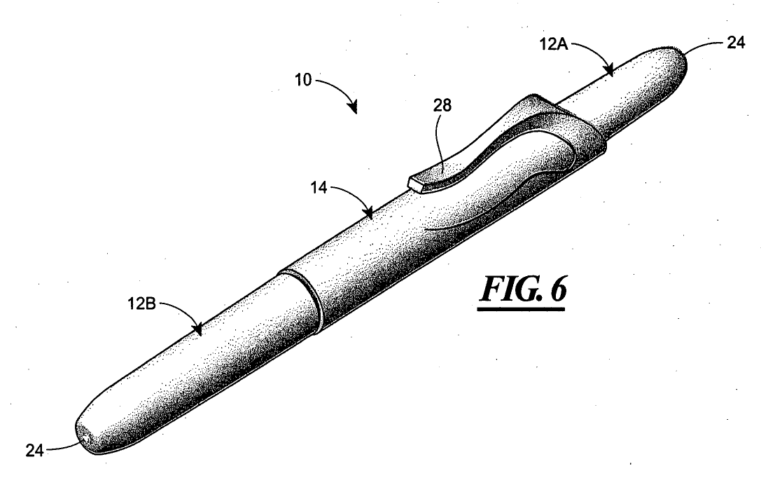

FIG. 5 illustrates a marker system 10, which includes a connector cap 14 comprising translucent plastic. The central connector cap 14 incorporates a central, interior wall 26, which separates the markers tips while the markers are in the capped position (e.g., as shown in FIGS. 1, 5, and 6). FIG. 5 also illustrates that the first and second receiving chambers 22A, 22B (shown in phantom lines) generally have an inside diameter sized to receive both an outside diameter of the marker barrel 16 (or other instrument housing) and an outside diameter of the marker ferrule 20. Generally, the first and second receiving chambers 22A, 22B have the same dimensions to simplify manufacturing. Similarly, the first and second marker barrels 16 and the first and second marker ferrules 20 generally have the same dimensions. As shown in FIGS. 6-8, the connector cap 14 can also include a clip 28 permitting attachment of the marker system 10 to a shirt pocket, a notebook, etc.

Thus, when one of the first and second instruments 12A, 12B is a marker, the connector cap 14 has an inside diameter sized to receive an outside diameter of the marker barrel 16 such that the marker barrel 16 extends a sufficient length into the connector cap 14 such that it can be securely inserted into and received by the connector cap 14. By receiving such a considerable portion of the marker barrel 16 in the connector cap, the marker 12A, 12B is secured and a writing point 18 is exposed or positioned for making written marks. Beneficially, the marker system 10 is not awkward to hold and maneuver (e.g., too long) when the marker barrel 16 is positioned in the connector cap 14, as previously described.

Additionally, because the outside diameter of the marker barrel 16 and an outside diameter of the connector cap 14 have substantially the same values at about the point of connection between these elements when the marker barrel is positioned in the connector cap 14, the consumer is not encumbered by a large disparity between these two diameters when using the marker system 10 to make written marks. Accordingly, the slope of the marker barrel 16 is selectively configured such that the marker barrel 16 outside diameter has substantially the same value as the connector cap 14 outside diameter at about the point of connection between these components. Furthermore, the length of the marker ferrule 20 is suitable for a secure connection when marker 12A, 12B is positioned for storage in the connector cap 14.

A variety of resins may be used to manufacture the marker barrels and connector cap, including but not limited to polyethylenes (e.g., high density polyethylene or linear low density polyethylene), polypropylenes (including structural foam comprising polypropylene), polyethylene terepthalates, polyvinyl chlorides, thermoplastic elastomers, polycarbonates, etc. However, other materials including but not limited to wood and metal may also be used to manufacture these components. Injection molding is typically used to manufacture the marker system components, but other methods may also be used.

The ink reservoir should be inert to the ink compositions. An example of a suitable ink reservoir is a melt-blown fibrous reservoir from Filtrona Company (Colonial Heights, Va.). The dimensions of the ink reservoir can be varied to fit the size of the outer marker barrel. Suitable ink reservoirs for use in the markers preferably have a reservoir fiber density between about 0.10 gram/cubic centimeter (g/cc) and about 0.50 g/cc.

The reservoir fibers can be manufactured from thermoplastic polymers such as, for example, polyesters, nylons, polypropylenes, and mixtures thereof. The fibers inside the reservoir can be linearly-oriented or entangled. To maintain the integrity of the ink reservoir towards aggressive solvents, the reservoir may be wrapped with a sheet of polypropylene or nylon. The reservoirs can be of any dimensions as long as the dimensions are sufficient for storing a predetermined amount of ink and for permitting the reservoir to fit into the desired marker body or other writing implement housing.

The nib should allow delivery of the ink composition contained in the ink reservoir. Fibers of the nib should be compatible with the solvent system of the ink composition and capable of retaining the ink composition. An exemplary nib is a polyester/urethane nib supplied by Teibow (GW402).

Suitable nib fibers can be manufactured from thermoplastic polymers such as, for example, polyester, polypropylene, nylon, and mixtures thereof. The nib fibers are typically bound by a second resin, which also should be insoluble in the ink composition solvent system. Exemplary resins include polyacetal and melamine.

Although the foregoing text sets forth a detailed description of numerous different embodiments of a marker system, it should be understood that the scope of coverage of this patent is not limited thereto. On the contrary, the detailed description is to be construed as exemplary only and does not describe every possible embodiment of a marker system. Accordingly, only such limitations that appear in the appended claims should limit the scope of coverage.

What is claimed is:

1. A connector system comprising:
(a) a first instrument, the first instrument comprising a first barrel and a first ferrule;
(b) a second instrument, the second instrument comprising a second barrel and a second ferrule; and,
(c) a connector cap comprising a cylindrical member including a first chamber and a second chamber;
wherein the first chamber of the connector cap is capable of receiving the first ferrule and the second chamber of the connector cap is simultaneously capable of receiving the second ferrule.

2. The connector system of claim 1, wherein the first instrument is a writing implement further comprising a first writing point extending from the first ferrule and a first ink reservoir in fluid communication with the first writing point.

3. The connector system of claim 2, wherein the first writing point is a porous nib.

4. The connector system of claim 2, wherein the second instrument is a writing implement further comprising a second writing point extending from the second ferrule and a second ink reservoir in fluid communication with the second writing point.

5. The connector system of claim 4, wherein the first writing point and the second writing point are porous nibs.

6. The connector system of claim 4, wherein the first ink reservoir comprises a first ink and the second ink reservoir comprises a second ink, and the first ink and the second ink have the same color.

7. The connector system of claim 4, wherein the first ink reservoir comprises a first ink and the second ink reservoir comprises a second ink, and the first ink and the second ink have different colors.

8. The connector system of claim 1, wherein the first instrument further comprises a component coupled to the first ferrule, the component being selected from the group consisting of a stylus, a laser pointer, a brush, a flashlight, a keychain holder, and a storage container.

9. The connector system of claim 1, wherein an interior wall is disposed between the first and second chambers.

10. The connector system of claim 1, wherein the first chamber of the connector cap is further capable of receiving the first barrel and the second chamber of the connector cap is simultaneously capable of receiving the second barrel.

11. The connector system of claim 10, wherein:
(i) the outside diameter of the first barrel is decreasing in a direction axially away from the first ferrule such that the outside diameter of the first barrel is substantially the same as the outside diameter of the connector cap at the point of connection to the connector cap when the first barrel is inserted into one of the chambers; and,
(ii) the outside diameter of the second barrel is decreasing in a direction axially away from the second ferrule such that the outside diameter of the second barrel is substantially the same as the outside diameter of the connector cap at the point of connection to the connector cap when the second barrel is inserted into one of the chambers.

12. A marker kit comprising:
(a) at least three writing implements, each of which comprises a barrel, a ferrule, a writing point extending from the ferrule, and an ink reservoir in fluid communication with the writing point; and,
(b) a connector cap having two receiving chambers capable of receiving either the barrels or the ferrules of the writing implements.

13. The marker kit of claim 12, wherein the writing points of the writing implements are porous nibs.

14. The marker kit of claim 12, wherein the outside diameter of the barrel is decreasing in a direction axially away from the ferrule such that the outside diameter of the barrel is substantially the same as the outside diameter of the connector cap at the point of connection to the connector cap when the barrel is inserted into one of the receiving chambers.

15. The marker kit of claim 12, wherein the connector cap comprises a substantially hollow tubular member.

16. The marker kit of claim 15, wherein the connector cap further comprises an interior divider wall

17. A writing system comprising:
(a) a first instrument, the first instrument comprising a first barrel, a first ferrule, a writing point extending from the first ferrule, and an ink reservoir in fluid communication with the writing point;
(b) a second instrument, the second instrument comprising a second barrel and a second ferrule; and,
(c) a connector cap, the connector cap comprising a first receiving chamber and a second receiving chamber;
wherein:
(i) the first receiving chamber is capable of receiving either the first barrel or the first ferrule; and,
(ii) the second receiving chamber is capable of receiving either the second barrel or the second ferrule.

18. The writing system of claim 17, wherein the second instrument further comprises a component coupled to the second ferrule, the component being selected from the group consisting of a stylus, a laser pointer, a brush, a flashlight, a keychain holder, and a storage container.
